(19) United States
(12) Patent Application Publication
(10) Pub. No.: US 2007/0216366 A1
(43) Pub. Date: Sep. 20, 2007

(54) Method for judging service life of primary battery

(76) Inventors: Shoichi Inamine, Sumoto-city (JP); Shinichi Itagaki, Sumoto-city (JP); Norihito Sumitomo, Sumoto-city (JP); Yoshihisa Ikeda, Minami-Awaji City (JP)

Correspondence Address: WENDEROTH, LIND & PONACK, L.L.P., 2033 K STREET N. W., SUITE 800, WASHINGTON, DC, 20006-1021, US

(21) Appl. No.: 11/717,040

(22) Filed: Mar. 13, 2007

(30) Foreign Application Priority Data
Mar. 15, 2006 (JP) 71868/2006
Feb. 6, 2007 (JP) 27211/2007

(51) Int. Cl. H02J 7/00

(52) U.S. Cl. 320/132

(57) ABSTRACT

A method for judging a service life of a primary battery is disclosed, in which, by using a battery pack having a built-in microcomputer, a primary lithium battery is discharged at a given time, a voltage of the primary lithium battery is measured at the time of discharge, and such measured voltage is compared with a specified reference voltage, so that when the measured voltage is less than the reference voltage, the primary lithium battery is judged to have reached the end of its service life. And, the given time is a periodic timing.

### BACKGROUND OF THE INVENTION

1. Field of the Invention

The present invention relates to a method for judging a service life of a primary battery and, in particular, a primary lithium battery.

2. Description of the Related Art

In Japanese Patent Laid-Open Publication No. 1993-297082, a nickel-cadmium battery (a secondary battery) or a dry battery (a primary battery) is first discharged to identify it as a nickel-cadmium battery or a dry battery, and then a residual capacity of such identified battery is judged on a basis of a battery voltage measured at the time of discharge.

### SUMMARY OF THE INVENTION

However, as disclosed in (Paragraph 0017 in) this Publication, a battery is identified, and a residual capacity based on a battery voltage present at the time of discharge is calculated and judged when the battery is loaded in equipment or when a user presses a button for monitoring the residual capacity.

When such primary battery is mounted to equipment which is less frequently used or which requires a sufficient residual capacity on use (such as in an emergency report system mounted on a motor vehicle and powered by a battery), it is essential to grasp the battery's residual capacity in advance.

The present invention has been made to solve such problem, and it is an object of the invention to provide a method for judging a service life of a primary battery, in which an under-capacity of the primary battery can be known beforehand.

One of the advantages of this invention is that a primary battery is discharged at a given time to measure a primary battery's voltage present at the time of discharge and then such measured voltage is compared with a specified reference voltage, so that when the measured voltage is less than the reference voltage, the primary battery is judged to have reached the end of its service life.

According to the above-described method for judging a service life, it is possible to constantly perceive the end of the primary battery's service life while reducing a decrease in battery capacity caused by the discharge, because a primary battery's voltage present at the time of discharge is measured at a given time or at a periodic timing to judge the service life of the battery.

In this method, the reference voltage is changed in accordance with a battery temperature, so that an appropriate end point of the battery's service life can be judged in correspondence with each battery temperature.

Another advantage of the invention is that a primary lithium battery is discharged at a given time to measure a primary battery's voltage present at the time of discharge and then such measured voltage is compared with a specified reference voltage, so that when the measured voltage is less than the reference voltage, the primary lithium battery is judged to have reached the end of its service life.

The given time as described above may be a periodic timing. Also, the above-mentioned reference voltage is featured in that the voltage level is changed in accordance with a battery temperature.

Further, according to the inventive method for judging a service life of a primary battery, a discharge mode can be measured to judge whether the primary battery has been discharged, without switching on a switching device which serves to discharge the primary battery via a discharge resistor, that is to say, in a state where the primary battery is not discharged via the discharge resistor.

Also with reference to an external electric load, according to the inventive method for judging a service life of a primary battery, a discharge mode (a history of a discharge) can be measured to judge whether the primary battery has been discharged to an external electric load, without switching on a switching device which serves to discharge the primary battery via a discharge resistor, namely, in a state where the primary battery is not discharged via the discharge resistor, that is to say, internally. According to this inventive method for judging a service life of a primary battery, when the external resistor to be employed is, for example, a power source for a vehicle-mounted emergency report system, it is important for the primary battery to be able to correctly start its operation in case of emergency, to assure its satisfactory operation, and to secure a discharge duration as required. Specifically, when the battery is used as a power source for the emergency report system, a report and other necessary information must be securely sent to a report center. As such, it is important that a judgment of a service life of the primary battery be made securely and correctly for guarantee, so that the emergency report system is unfailingly operated in case of emergency. Such requirements can be accomplished by detecting a discharge mode (a history of a discharge) that the primary battery is discharged via other than the discharge resistor, that is, the battery is discharged to an external electric load. When the discharge mode is detected, a user can be informed of a need for battery replacement as an unassured state based on a judgment of the service life, like by judging that the primary battery has reached the end of its service life or needs to be replaced. Thus, by battery replacement, a new one with a sufficient residual capacity can be mounted, assuring an unfailing operation of the emergency report system in case of emergency.

Indeed, according to the inventive method for judging a service life of a primary battery, when a discharge mode is measured, the battery can be judged to have reached the end of its service life.

Further, according to the inventive method for judging a service life of a primary battery, a discharge mode in the primary battery can be measured by means of an MPU which is operated with a power delivered from a separate source.

By employing the method in which the discharge mode in the primary battery can be measured by means of the MPU which is operated with a power delivered from a separate source, the judgment of a service life of the primary battery does not require an electrical power to be delivered from the primary battery, so that the service life of the primary battery can be extended.

Further, according to the inventive method for judging a service life of a primary battery, a battery voltage is detected without switching on a switching device which serves to discharge the primary battery via a discharge resistor, such battery voltage is compared with a subsequent battery voltage to be detected after a given time, and a voltage drop in the primary battery is measured, so that when the voltage drop is larger than a predetermined value, the primary battery can be judged to be in a discharge mode.

Further, with reference to a discharge mode of a primary battery mounted to equipment, a voltage drop in the primary battery after a given time is measured without switching on a switching device which serves to discharge the primary battery via a discharge resistor, so that when the voltage drop is larger than a predetermined value, the primary battery is judged to be in a discharge mode. In this method, a discharge mode can be detected by detecting a voltage drop, in a manner of detecting a voltage of the primary battery and storing such detected voltage in a non-volatile memory to compare with a detected voltage which has been stored, a given time before, in the non-volatile memory. By this method, the discharge mode can be unfailingly detected by storing the detected voltage in the non-volatile memory, in a state where a power is not delivered from a separate source.

Further, according to the inventive method for judging a service life of a primary battery, a voltage drop can be detected by detecting a voltage of the primary battery and storing such detected voltage in a non-volatile memory to compare the detected voltage which is stored in the non-volatile memory with a primary battery's subsequent voltage which is to be detected after a given time.

Further, according to the inventive method for judging a service life of a primary battery, a discharge mode can be judged by detecting a discharge current of the primary battery without switching on a switching device which serves to discharge the primary battery via a discharge resistor, so that when the discharge current is detected, the primary battery is judged to have been discharged.

Also, with reference to a discharge mode of a primary battery mounted to equipment, a discharge mode can be judged by detecting a discharge current of the primary battery without switching on a switching device which serves to discharge the primary battery via a discharge resistor, so that when a discharge current is detected, the primary battery is judged to have been discharged.

Still further, according to the inventive method for judging a service life of a primary battery, a discharge mode of the primary battery can be stored in the non-volatile memory.

Further, according to the method in which a discharge mode of the primary battery can be stored in a non-volatile memory, even after a power supply from a vehicle-mounted battery has been shut down, a history of the discharge mode can be detected when a power is supplied again, because the discharge mode has been stored in the non-volatile memory.

Yet further, according to the inventive method for judging a service life of a primary battery, a discharge resistor can be employed in discharging the primary battery, and such discharge resistor may be a fuse or a PTC element.

The above and further objects of the present invention as well as the features thereof will become more apparent from the following detailed description to be made in conjunction with the accompanying drawings.

### BRIEF DESCRIPTION OF THE DRAWINGS

FIG. 1 is a block diagram illustrating a circuit of the battery pack in accordance with one embodiment of the present invention;

FIG. 2 is a graph depicting a voltage level and a current value which are present at the time of discharge in accordance with the embodiment of the invention;

FIG. 3 is a graph depicting a voltage level and a current value which are present at the time of discharge at various battery temperatures;

FIG. 4 is a block diagram illustrating a circuit of the battery pack in accordance with an alternative embodiment of the invention; and

FIG. 5 is a flow chart showing how the battery pack, illustrated in FIG. 4, detects a service life and discharge mode of a primary lithium battery.

### DETAILED DESCRIPTION OF THE PREFERRED EMBODIMENTS

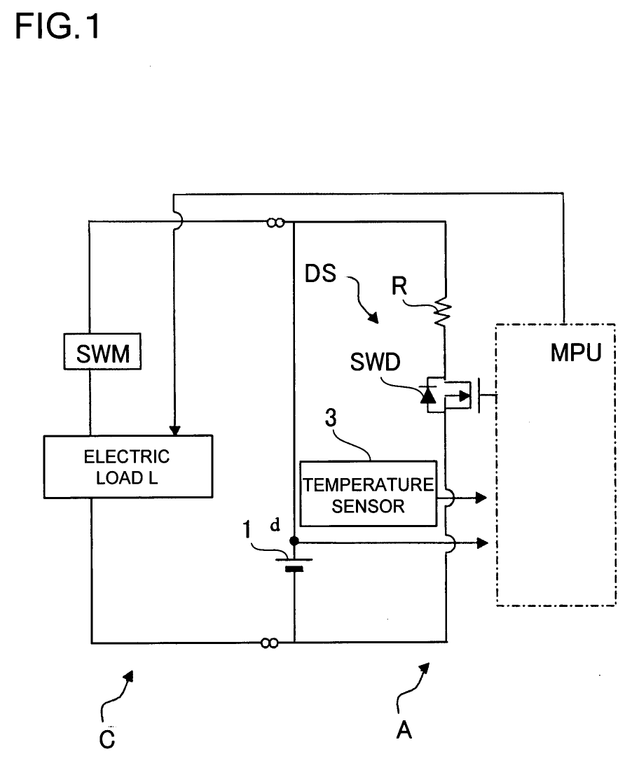

Embodiments of the invention will now be described in greater detail in conjunction with the attached drawings. As can be seen in FIG. 1, an embodiment includes a battery pack A, and electronic equipment C powered by the battery pack A. The battery pack A can be replaced when it has reached the end of its service life with its battery capacity having been reduced. Alternatively, as will be described below, a battery cell 1 alone may be replaced at the end of its service life.

As one example of the electronic equipment C, a vehicle-mounted emergency report system C can be employed in a manner as described below. An electric load L is driven with the power delivered from the battery pack A. In the case of a vehicle accident or breakdown, a motion switch SWM on the report system C mounted to the vehicle is either pressed by the driver or occupant or self-generated when sensing a shock, so that the report system C automatically obtains vehicle's location information utilizing, for example, a GPS which is separately provided within the electric load L, and such location information is sent by means of a radio wave. In addition, information about emergency situations, such as an accident and breakdown, is sent via the radio wave. When such information on the location and emergency situations is received by an emergency report center which operates under a centralized management, the center makes a response based on the information on the location and emergency situations. The response made by the center may include giving the vehicle driver or occupant some emergency-related advice over the phone available in or around the vehicle and sending an ambulance.

Provided in the battery pack A are a primary lithium battery cell 1, a temperature sensor 3 including a thermistor disposed in close contact with the battery cell 1, and a microprocessor unit (collectively referred to as an MPU) which is a microcomputer for monitoring and controlling a discharge of the battery cell 1. Although not illustrated in detail, the microcomputer's MPU is electrically powered by the battery cell 1 or automotive battery.

Built in the microcomputer's MPU is an A/D converter to input and digitally convert a battery voltage (measured at point d) and an analog voltage fed out of the temperature sensor 3. Thus, the microcomputer's MPU serves as a control means for performing a calculation, comparison and judgment regarding a service life of the battery.

By using the microcomputer's MPU, the primary lithium battery cell 1 is discharged at a given time, a battery voltage is measured which is present at the time of discharge, and then such measured voltage is compared with a specified reference voltage, so that when the measured voltage is less than the reference voltage, the primary battery is judged to have reached the end of its service life. When the battery is judged to have reached the end of its service life, a signal is sent out of the microcomputer's MPU to the electric load L, based on such judgment. The report system C which has received a signal regarding the service life is so designed as to indicate such service life on an LED or LCD (not shown).

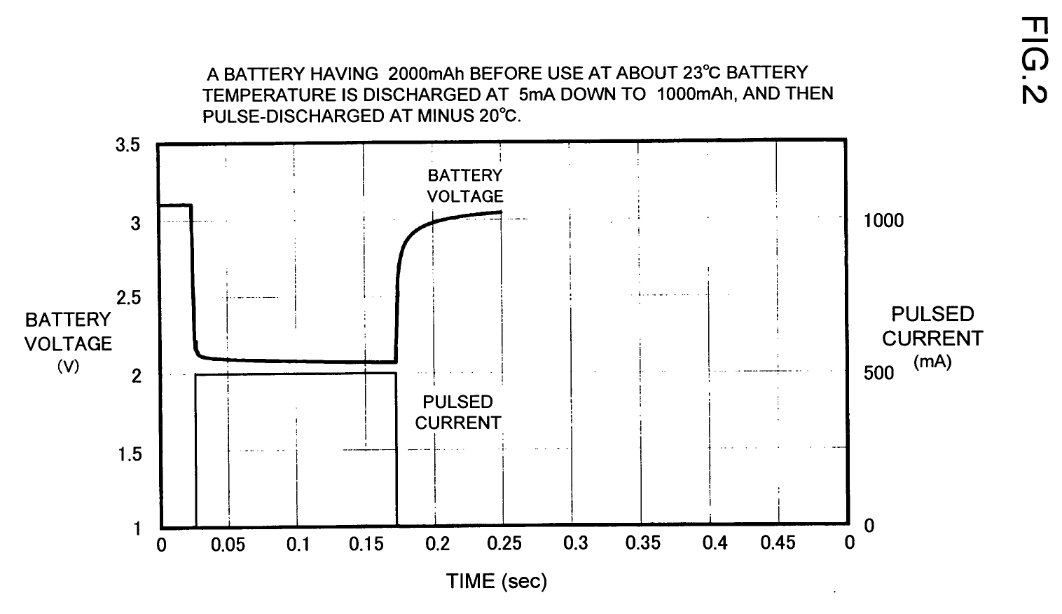

Provided in the battery pack A is a discharge circuit DS connected in parallel with the battery cell 1. The discharge circuit DS has a discharge resistor R (of the order of about 2 to 100Ω) and a switching device SWD (such as an FET) connected mutually in series. And, the microcomputer's MPU controls a gate signal of the switching device SWD. Also as can be seen in FIG. 2, at the time of discharge, it is possible to employ such resistance as may allow a current to flow which ranges between about 200 mA and 1 A, preferably 500 mA for example, or the current may be equivalent to an operating current which flows at the time of driving the report system C. The microcomputer's MPU allows the battery cell 1 to be discharged to the discharge resistor R by setting the gate signal to be an ON-signal at a periodic timing as a given time, for example once in 10 hours to 3 months, for 10 to 1000 mSec, for example 200 mSec or 500 mSec. Also, as an alternative given time, the battery cell 1 may be discharged, at the time of driving the vehicle, to detect a battery voltage, using a detection means which is separately provided (such as a method of detecting an operation of the ignition key of the vehicle).

And, as shown in FIG. 2, when the voltage becomes stable since commencement of discharge (such as after about 5 to 20 mSec since the gate signal was switched on), the microcomputer's MPU measures a battery voltage to compare it with a specified reference voltage. It should be noted that FIG. 2 depicts a variation in a battery voltage and current when a battery, which has a capacity of 2000 mAh before use (i.e., a rated capacity) at a battery temperature of about 23° C., is discharged at a current of 5 mA until the battery reaches a residual capacity of 1000 mAh and also when the battery is pulse discharged at a battery temperature of minus 20° C.

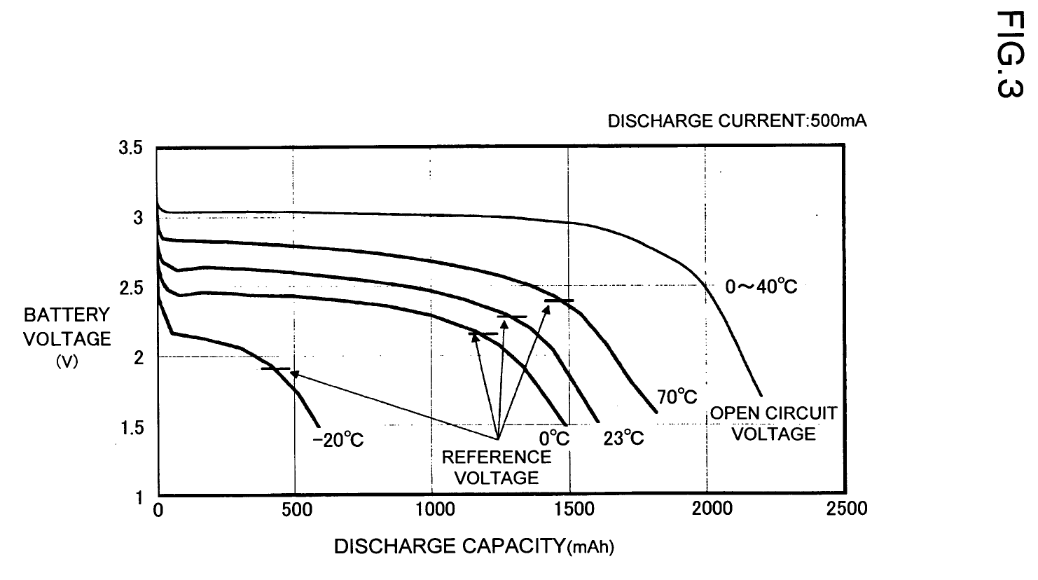

Such specified reference voltage differs in accordance with a battery temperature measured with the temperature sensor 3, as shown in FIG. 3. FIG. 3 depicts battery voltages which are present at the time of discharge (with a discharge current of 500 mA) at various temperatures with respect to a discharge capacity (a discharge duration). In FIG. 3, for the primary lithium battery cell 1, the specified reference voltage is set to be, as illustrated, a level present in the vicinity before the battery voltage decreases to a great extent when the discharge comes to its end, based on the graph in FIG. 3. Such specified reference voltage in accordance with each individual temperature is stored, as a data table, in the memory in the microcomputer's MPU to be employed for a comparison and calculation. It should be noted that, in FIG. 3, a battery was used which has a capacity of 2000 mAh at the time of discharge at a current of 5 mA at a battery temperature of about 23° C. Also depicted in FIG. 3 is an open circuit voltage present at a battery temperature of 0-40° C. As shown, there is not much difference in an open circuit voltage in accordance with the temperatures, which can be depicted in a single piece of discharge curve; it is difficult to properly obtain information on a residual capacity in accordance with each individual temperature. Also, since such open circuit voltage tends to be unstable in corresponding with a residual capacity, a battery voltage at the time of discharge is measured, in the embodiment of the invention, to allow such battery voltage to correspond with the residual capacity.

Now, to define the end of the battery's service life, it means that the residual capacity has become smaller and yet the primary lithium battery cell 1 can be discharged even below the specified reference voltage, which will be apparent from the graph in FIG. 3.

As described above, the primary lithium battery cell 1 is discharged at a given time, a battery voltage is measured which is present at the time of discharge, and then such measured voltage is compared with a specified reference voltage, so that when the measured voltage is less than the reference voltage, the primary battery is judged to have reached the end of its service life. However, it can also be arranged that the battery is judged to have reached the end of its service life when such measured voltage is found to be less than the reference voltage in sequential repetition, for example two to five times (preferably three times).

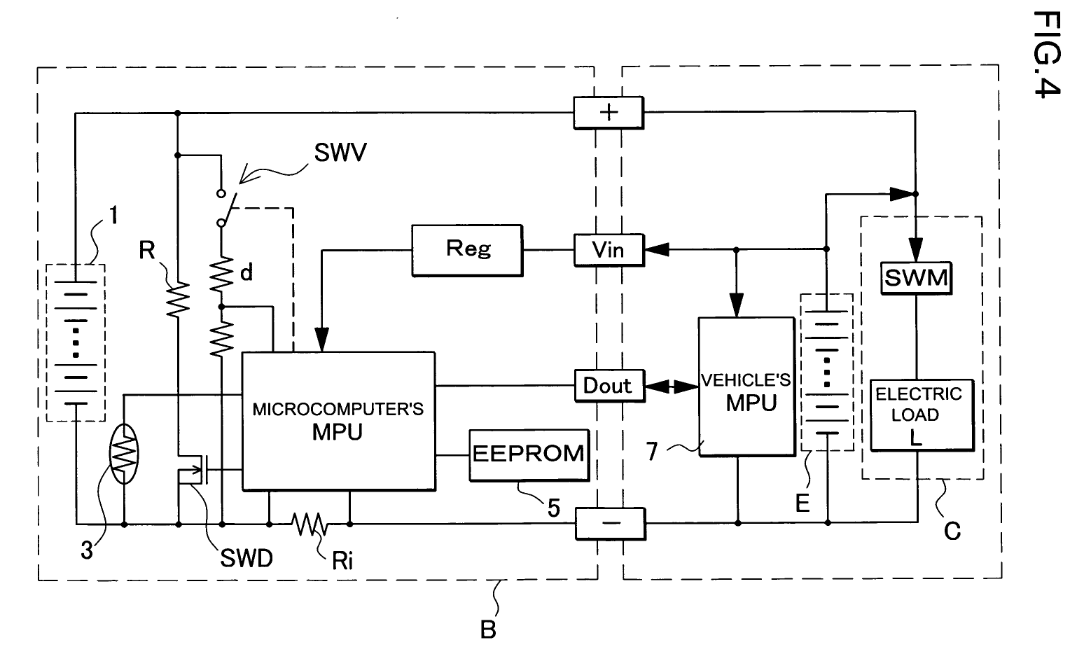

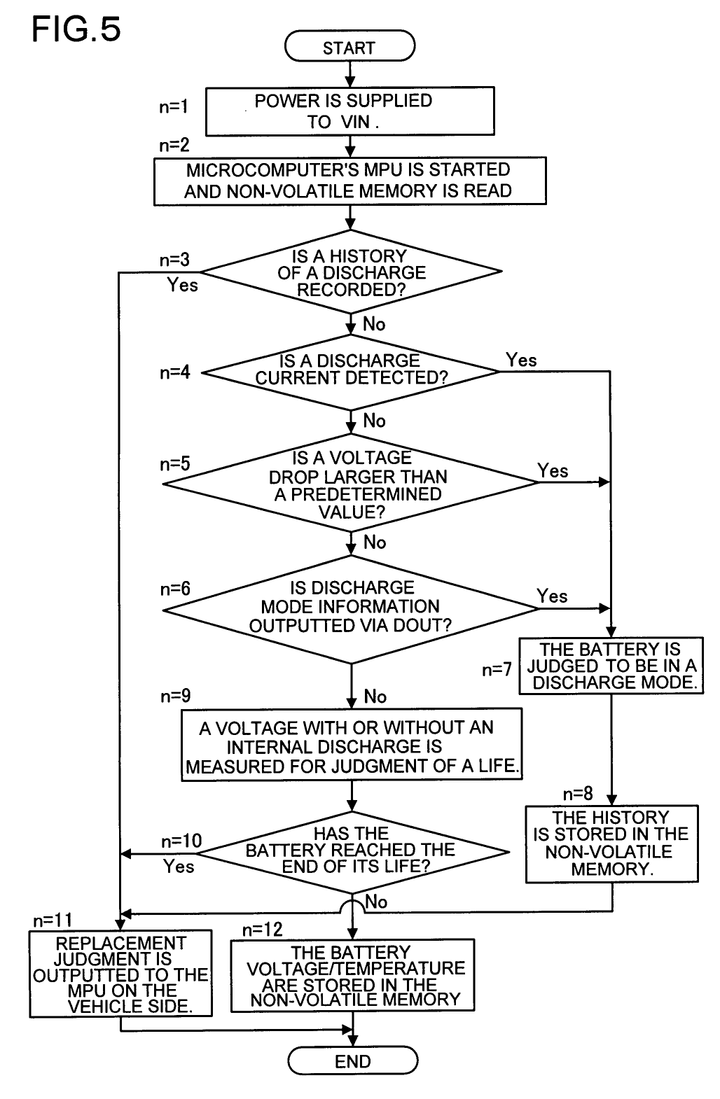

Further, an alternative embodiment of the invention will be described in detail in conjunction with the circuit diagram in FIG. 4 and the flow chart in FIG. 5. Description of the configuration will be omitted which corresponds with the above-described embodiment. As can be seen in FIG. 4, in this particular embodiment as well, a battery pack B is connected to electronic equipment C such as the report system C as described in the above-mentioned embodiment, the electronic equipment being powered by the battery pack B. When the battery has reached the end of its service life with its battery capacity having been reduced or when the battery is discharged, the battery pack B is replaced to stably deliver an electric power to the electronic equipment C Alternatively, a battery cell 1 alone may be replaced in the battery pack B.

As an example of electronic equipment C, a vehicle-mounted emergency report system C can be employed in the same manner as illustrated in FIG. 1. An electric load L in the emergency report system C is electrically powered by either of an automotive battery E or the battery pack B. The electric load L in the emergency report system C is usually powered by the automotive battery E, while the battery pack B serves as a battery backup for a power supply to the electric load L in the emergency report system C when the automotive battery E is unable to function as a power source, like after a vehicle accident.

The microcomputer's MPU built in the battery pack B, as shown in this circuit diagram, serves to measure a battery voltage, a battery temperature as well as a current which flows through the battery cell 1. Here, at the time of measuring the battery voltage, the microcomputer's MPU switches on a switch SWV, measures a voltage at a measurement point d, and converts in the microcomputer's MPU such voltage to a battery voltage to be measured. Likewise, the battery voltage is measured by switching off the switch SWV. A battery current is detected by measuring a voltage present across the terminals in a current detection resistor Ri which is connected to the battery cell 1 in series. The current is worked out by detecting the voltage, because the voltage of the current detection resistor Ri is proportional to an electrical resistance of the current detection resistor Ri. A voltage signal and a current signal are converted to digital signals by a built-in A/D converter, the digital signals are calculated by the microcomputer's MPU, and thus a judgment is made on the battery's service life, as described in the above-mentioned embodiment, and on a discharge mode (a history of a discharge). Here, to define the discharge mode, it means a history in which the battery pack B has delivered an electric power to the electric load L in the emergency report system C. And, since the battery pack B serves as a battery backup, it is essential that a residual capacity be sufficiently reserved in the battery cell 1. Hence, it is desirable that the battery pack B or battery cell 1 be replaced whenever there occurs a discharge mode (a history of a discharge) indicative of a discharge to the electric load L in the emergency report system C. This is because, after the discharge, it is difficult to secure a discharge duration as required and guarantee that a discharge can still be continued. In other words, a detection and judgment of a discharge mode mean that a residual capacity has become smaller in the primary lithium battery, meaning further that the battery is judged to have reached the end of its service life. The discharge from the battery pack B to the electric load L in the emergency report system C is performed, at an output of 1 A, for about 2 to 9 minutes, e.g., for about 5 minutes.

Further, in the same manner as performed in accordance with the above-described embodiment for the battery pack A in FIG. 1, the primary lithium battery cell 1 is (internally) discharged at a given time, a battery voltage is measured which is present at the time of discharge, and then such measured voltage is compared with a specified reference voltage, so that when the measured voltage is less than the reference voltage, the primary battery is judged to have reached the end of its service life.

That is to say, a voltage of the primary lithium battery cell 1 is measured by switching on a switching device SWD from its switched-off state at a given time and discharging via a discharge resistor R. Such discharge resistor R is available for about 2 to about 100Ω, specifically for about 5 to 30Ω, and preferably for about 15Ω.

Such discharge resistor R to be employed may include a resistance component such as in a fusing arrangement and a PTC element such as a PTC thermistor (PTC stands for Positive Temperature Coefficient). Use of any such resistor prevents an abnormal overcurrent from flowing through, because when such abnormal overcurrent flows through the discharge resistor R at the time of internal discharge, the fuse blows in the fusing arrangement or a larger resistance prevails in the PTC element. Here, at a given time as explained in the above embodiment in which the switching device SWD is switched on from its switched-off state, the microcomputer's MPU is electrically powered by the automotive battery E, as will be described below.

Also, the microcomputer's MPU is powered from the automotive battery E in the vehicle of electrically loading side, through a terminal Vin by means of a regulator Reg. Here, the microcomputer's MPU does not need to operate constantly, because the MPU serves to judge and record a service life and discharge mode (history of a discharge) of the battery. As such, power supply from the automotive battery E to the microcomputer's MPU is performed about one time in one day, for 2 to 30 seconds (preferably for 5 to 15 seconds), under instructions from the vehicle's MPU 7. Except for the time duration of delivering an electric power, the microcomputer's MPU remains shutdown (i.e., in an inoperative state). By this power supply method, when compared with a consumption of a power from the primary lithium battery cell 1 by the microcomputer's MPU, it becomes possible to extend a period of warranty for a primary lithium battery with the same capacity, namely, a conservation period as a battery backup when the battery pack B is mounted to the emergency report system C. It should be noted that, instead, the microcomputer's MPU may be so arranged as to be constantly powered from the automotive battery E in a vehicle of electrically loading side and that the power to the microcomputer's MPU may be so arranged as to be delivered from the primary lithium battery cell 1 as well.

Further, the microcomputer's MPU detects a discharge mode which is indicative of a history that the battery has been discharged (a history that the primary battery cell 1 is electrically communicated to the electric load L in the report system C) without undergoing a discharge within the battery pack (an internal discharge), in other words, without discharging the primary lithium battery cell 1 to the discharge resistor R with the switching device SWD being switched on. The discharge mode is detected by detecting a voltage drop in the primary lithium battery cell 1 and a current flowing through the battery, as will be described below in detail. When the battery pack B is judged to have reached the end of its service life or to be in a discharge mode, a signal indicative of the battery's state, namely, a signal indicative of the end of the battery's service life or a signal indicative of the discharge mode, is sent from the battery pack MPU to the loading side MPU 7. These signals indicative of the battery's state (signals indicative of a judgment on replacement) serve to indicate the need for battery replacement, and the signals are sent to the vehicle's MPU 7 of electrically loading side via a data output terminal (Dout) in the battery pack. The electrically loading side, which has received the signal indicative of the end of the service life of the battery pack B or the signal indicative of the discharge mode, gives indication of the end of the service life of the battery pack B on an LED or LCD, and also the electrically loading side gives indication of the history that the battery pack B has been discharged (indication that an operation cannot be guaranteed as a battery backup after the discharge of the battery pack B) (not shown). Thus, a vehicle distributor or user can replace the battery pack B or the primary lithium batter 1 based on such indication, so that the electric load L in the emergency report system C is placed into a state of constantly having a power delivered from the battery pack B.

To describe in detail, the microcomputer's MPU judges a discharge mode (a history of a discharge) based on the three detection methods 1-3 to follow.

### Detection Method 1 (Detection Based on a Voltage Drop): Equivalent to the Step n=5 in the Flow Chart in FIG. 5, as Described Below.

When not internally discharged, the battery voltage is measured, and such measured battery voltage is compared with the battery voltage which has been previously measured. When a voltage drop is found to be larger than a predetermined value (of an order of about 0.05-1.00V, e.g., of about 0.1V), the battery is judged to be in a discharge mode because a history of a discharge is present. That is to say, when the battery pack B is discharged to the electric load L in the emergency report system C, in other words, when the battery pack B is discharged to a circuit other than the discharge resistor R, namely to a circuit other than a discharge path within the battery pack, the primary lithium battery cell 1 undergoes a larger voltage drop. On the other hand, when the battery is not discharged to the electric load L, a voltage drop in the primary lithium battery cell 1 is substantially equivalent to zero. Consequently, without switching on the switching device SWD which serves to discharge the primary lithium battery cell 1 via the discharge resistor R, a battery voltage of the primary lithium battery cell 1 is measured after a certain time interval (after a given time) to measure a relevant voltage drop, so that when the voltage drop is found to be larger than the predetermined value, the primary lithium battery cell 1 is judged to be in a discharge mode. The microcomputer's MPU detects a voltage of the primary lithium battery cell 1 at a sampling timing of, for example, one time in a day and compares such detected voltage with the previously measured voltage to detect a voltage drop. A sampling timing for detecting a voltage drop in the primary lithium battery cell 1 may also be set to be once in several hours or in several days. Instead of employing such sampling timing, in the case of the battery pack B having a vehicle's emergency reporting system C as the electric load L, it is also possible to measure a voltage of the primary lithium battery cell 1 every time when a vehicle's ignition switch is turned on and to compare such voltage with the previously measured voltage to detect a discharge mode based on a detected voltage drop. In this case, since the sampling timing for detecting a battery voltage is not regularly set, a consideration is given to an elapsed time, an internal discharge, battery's self-discharge or the like based on such sampling timing, so that a voltage drop in the primary lithium battery cell 1 is calculated when the battery pack B is not discharged to the electric load L in the emergency report system C, and thus, when the measured voltage drop in the battery is larger than a calculated voltage level, the battery is judged to be in a discharge mode.

Detection Method 2 (Current Detection by Means of a Current Detection Resistor Ri): Equivalent to the Step n=4 in the Flow Chart in FIG. 5, as Described Below.

At the time when the microcomputer's MPU is electrically powered from the automotive battery E, the microcomputer's MPU detects a discharge mode based on a detected current of the primary lithium battery cell 1, by detecting a discharge current flowing through the current detection resistor Ri when the battery pack B (the primary lithium battery cell 1) is discharged to the electric load L in the emergency report system C. The microcomputer's MPU judges the battery to be in a discharge mode when a current is detected in a controlled state that the switching device SWD is switched off. Such discharge mode is detected when the microcomputer's MPU in the battery pack B is in an operating state. The microcomputer's MPU comes into its operating state when a power is delivered from the automotive battery E. When an internal discharge does not exist with the switching device SWD being switched off, the microcomputer's MPU in its operating state detects a current to judge the battery to be in a discharge mode.

Detection Method 3 (Detection Based on Discharge Mode Information Available from the Vehicle Side): Equivalent to the Step n=6 in the Flow Chart in FIG. 5, as Described Below.

In view of the fact that the microcomputer's MPU is limited to a smaller amount of operating time, when the microcomputer's MPU is not in its operating state (in an inoperative period), it can be considered that the primary lithium battery cell 1 in the battery pack B is discharged to the electric load L in the report system C. Thus, as a function on the vehicle side, when the vehicle is equipped with a function of detecting a discharge from the battery pack B, information indicative of a discharge mode is inputted to the battery pack B from the vehicle's MPU 7 via the terminal Dout, so that the microcomputer's MPU judges the battery to be in a discharge mode (a history of a discharge).

Further, the battery pack B shown in FIG. 4 has a non-volatile memory 5 (such as EEPROM) connected to the microcomputer's MPU. It should be noted that the non-volatile memory (such as EEPROM) can also be embedded in the microcomputer's MPU. The non-volatile memory 5 detects a voltage of the primary lithium battery cell 1 to store such detected voltage in the memory. As explained in the above-described Detection Method 1 (detection based on a voltage drop), the battery pack B detects a voltage drop by comparing a voltage of the primary lithium battery cell 1 subsequently detected after a certain time interval (e.g., after a given elapsed time), with the previously detected voltage which has been stored in the non-volatile memory 5. The battery pack B equipped with the non-volatile memory 5 stores a previously detected voltage of the primary lithium battery cell 1, with a power supply from the automotive battery E being shut down. As the battery pack B is thus equipped with the non-volatile memory 5, the battery pack B is able to detect a voltage drop in the primary lithium battery cell 1, even when the microcomputer's MPU is not electrically powered constantly and when a power supply is shut down from the automotive battery E to the microcomputer's MPU. It is because the detected voltage of the primary lithium battery cell 1 is stored in the non-volatile memory 5 while the microcomputer's MPU is in its inoperative state.

Further, the non-volatile memory 5 stores a discharge mode of the primary lithium battery cell 1 as well as a voltage and temperature of the battery. Since the battery pack B stores the discharge mode, battery voltage and battery temperature in the non-volatile memory 5 even while a power supply from the vehicle is shut down, the discharge mode, battery voltage and battery temperature which are stored in the non-volatile memory 5 can be sent to the vehicle side when the battery pack B comes to be electrically powered from the automotive battery E.

The battery pack shown in FIG. 4 detects a service life and discharge mode of the primary lithium battery in accordance with the following steps as illustrated in FIG. 5.

### Steps n=1 Through 3

The microcomputer's MPU in the battery pack B is electrically powered via the terminal Vin from the automotive battery E in the vehicle of electrically loading side, and the microcomputer's MPU in the battery pack B comes into its operating state, so that the content stored in the non-volatile memory 5 (such as EEPROM) is read to judge whether a history of a discharge is present. Such power supply from the automotive battery E is performed about one time in a day, for about 2 to 30 seconds (preferably for about 5 to 15 seconds) in accordance with the present embodiment, and the power supply from the automotive battery E is stopped when the steps n=1 through 12 are completed.

### Steps n=4 Through 8

In these steps, the microcomputer's MPU judges whether the primary lithium battery cell 1 is in a discharge mode (a history of a discharge) while the microcomputer's MPU is in its operating state.

In the step n=4, while the microcomputer's MPU is in its operating state, the current detection resistor Ri detects a discharge current to judge a discharge mode (Detection Method 2 of detecting a current by means of the current detection resistor Ri, as described above).

In the step n=5, with regard to a battery voltage measured and detected in accordance with the ensuing step n=9, such measured battery voltage (this battery voltage, relative to the previously measured and detected battery voltage, is labeled as a subsequent battery voltage measured at a certain time interval (after a given time)) is compared with the previously measured battery voltage which is stored in EEPROM 5 after a given time. When a voltage drop is found to be larger than a predetermined value, the battery is judged to be in a discharge mode (Detection Method 1: detection based on a voltage drop, as described above).

In the step n=6, as a function on the vehicle side, the vehicle is equipped with a function of detecting a discharge from the battery pack B, so that information indicative of a discharge mode is inputted from the vehicle's MPU 7 on the vehicle side to judge the battery to be in a discharge mode (Detection Method 3: detection based on discharge mode information available from the vehicle side, as described above).

In the step n=7, when the battery is judged to be in a discharge mode, the relevant history is stored in the non-volatile memory 5 (such as EEPROM) in accordance with the subsequent step n=8. After the step n=8 to be followed by the step n=11, a replacement judgment regarding the battery pack B is outputted to the MPU on the vehicle side. That is to say, while the electrical power is delivered from the automotive battery E, the discharge mode which is stored in the non-volatile memory (such as EEPROM) is sent, in the form of a discharge mode signal as a signal of a replacement judgment, to the vehicle's MPU 7 in the vehicle of electrically loading side from the microcomputer's MPU in the battery pack B.

### Steps n=9 Through 11

When the battery is not in a discharge mode, the switching device SWD is switched on or off at a given time, a voltage of the primary lithium battery cell 1 is detected based on when discharged internally to the discharge resistor R or when not discharged internally. As explained in the first embodiment described above, a battery voltage is measured which is present at the time of discharge, and such measured voltage is compared with a specified reference voltage, so that when the measured voltage is less than the reference voltage, the battery is judged to have reached the end of its service life. And, when the battery is judged to have reached the end of its service life, a signal of the end of the service life is outputted as a signal of a replacement judgment regarding the battery pack B to the MPU on the vehicle side, in accordance with the step n=11.

### Step n=12

When the primary lithium battery cell 1 has not reached the end of its service life, the battery voltage and battery temperature, when discharged internally and when not discharged internally, are stored in the non-volatile memory 5 (EEPROM).

And, after the steps n=11, n=12, the power supply is stopped from the automotive battery E to the microcomputer's MPU.

Although a primary lithium battery cell 1 is employed as a battery in the above-described embodiments, it is possible for the present invention to be applied to other kinds of primary battery.

It should be apparent to those with an ordinary skill in the art that, while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the spirit and scope of the invention as defined in the appended claims.

The present application is based on Application No. 2007-027211 filed in Japan on Feb. 6, 2007, and Application No. 2006-71868 filed in Japan on Mar. 15, 2006, the contents of which are incorporated herein by reference.

What is claimed is:

1. A method for judging a service life of a primary battery, the method comprising the steps of:
discharging a primary battery at a given time;
measuring a primary battery's voltage present at the time of discharge; and
comparing such measured voltage with a specified reference voltage, so that when the measured voltage is smaller than the reference voltage, the primary battery is judged to have reached the end of its service life.

2. The method for judging a service life of a primary battery as recited in claim 1, wherein the primary battery comprises a primary lithium battery.

3. The method for judging a service life of a primary battery as recited in claim 1, wherein the given time is a periodic timing.

4. The method for judging a service life of a primary battery as recited in claim 1, wherein the reference voltage is changed in accordance with a battery temperature.

5. The method for judging a service life of a primary battery as recited in claim 1, wherein a discharge mode is measured which indicates whether the primary battery has been discharged without switching on a switching device serving to discharge the primary battery via a discharge resistor.

6. The method for judging a service life of a primary battery as recited in claim 5, wherein when the primary battery is found to be in a discharge mode, the primary battery is judged to have reached the end of its service life.

7. The method for judging a service life of a primary battery as recited in claim 6, wherein the discharge mode of the primary battery is measured by means of an MPU electrically powered from a separate source.

8. The method for judging a service life of a primary battery as recited in claim 7, wherein a battery voltage is detected without switching on the switching device serving to discharge the primary battery via the discharge resistor, such battery voltage is compared with a subsequent battery voltage to be detected after a given time, and a voltage drop in the primary battery is measured, so that when the voltage drop is larger than a predetermined value, the primary battery is judged to be in a discharge mode.

9. The method for judging a service life of a primary battery as recited in claim 8, wherein a voltage of the primary battery is detected, such detected voltage is stored in a non-volatile memory, and a subsequent voltage of the primary battery to be detected after a given time is compared with the detected voltage being stored in the non-volatile memory, so that a voltage drop is detected.

10. The method for judging a service life of a primary battery as recited in claim 7, wherein a discharge current of the primary battery is detected without switching on a switching device serving to discharge the primary battery via a discharge resistor, so that when the discharge current is detected, the primary battery is judged to have been discharged.

11. The method for judging a service life of a primary battery as recited in claim 5, wherein a discharge mode of the primary battery is stored in the non-volatile memory.

12. The method for judging a service life of a primary battery as recited in claim 7, wherein a discharge resistor is employed in discharging the primary battery, and such discharge resistor is a fuse or a PTC element.
